(19) United States
(12) Patent Application Publication
(10) Pub. No.: US 2013/0311253 A1
(43) Pub. Date: Nov. 21, 2013

(54) MOBILE DEVICE REAL ESTATE LISTING METHOD AND APPARATUS

(71) Applicant: Joseph Sabella, East Islip, NY (US)

(72) Inventor: Joseph Sabella, East Islip, NY (US)

(21) Appl. No.: 13/891,573

(22) Filed: May 10, 2013

Related U.S. Application Data
(60) Provisional application No. 61/647,729, filed on May 16, 2012.
(60) Provisional application No. 61/693,041, filed on Aug. 24, 2012.

(51) Int. Cl. G06Q 50/16

(52) U.S. Cl. CPC G06Q 50/167; G06Q 30/0241
USPC 705/14.4; 705/316

(57) ABSTRACT

According to some embodiments, a method and apparatus are provided to wirelessly facilitate the sale of real estate, the method and apparatus to receive data associated with a particular real estate property and an electronic signature of a seller of the particular real estate property. An executed contract based on the received data and the received electronic signature is created and in response to the executed contract, the received data is automatically transmitted, wirelessly, to an online listing service.

### BACKGROUND

When an owner of a house, condominium or other particular real estate property desires to sell their property, the property owner (e.g. a seller) will typically employ a broker (e.g., a Realtor or agent) and the broker will facilitate the sale of the property. However, the process of getting a property listed, so that its existence is known to the public, is a long and cumbersome process that will take several days before the availability of the property is known.

### BRIEF DESCRIPTION OF THE DRAWINGS

FIG. 1 illustrates a method according to some embodiments.

FIG. 2 illustrates an application home screen according to some embodiments.

FIG. 3 illustrates an agent setup screen according to some embodiments.

FIG. 4 illustrates an input screen to some embodiments.

FIG. 5 illustrates a property data screen according to some embodiments.

FIG. 6 illustrates a contract screen according to some embodiments.

FIG. 7 illustrates a contract screen according to some embodiments.

FIG. 8 illustrates a signature screen according to some embodiments.

FIG. 9 illustrates a signed contract according to some embodiments.

FIG. 10 illustrates a marketing flyer according to some embodiments.

FIG. 11 illustrates photographic images according to some embodiments.

FIG. 12 illustrates a web page according to some embodiments.

FIG. 13 illustrates a computing system according to some embodiments.

FIG. 14 illustrates an open house data screen according to some embodiments.

FIG. 15 illustrates an embodiment of an offer screen.

FIG. 16 illustrates an embodiment of an offer screen.

FIG. 17 illustrates an embodiment of an offer screen.

FIG. 18 illustrates an embodiment of a vendor screen.

FIG. 19 illustrates an embodiment of an open house screen.

### DETAILED DESCRIPTION

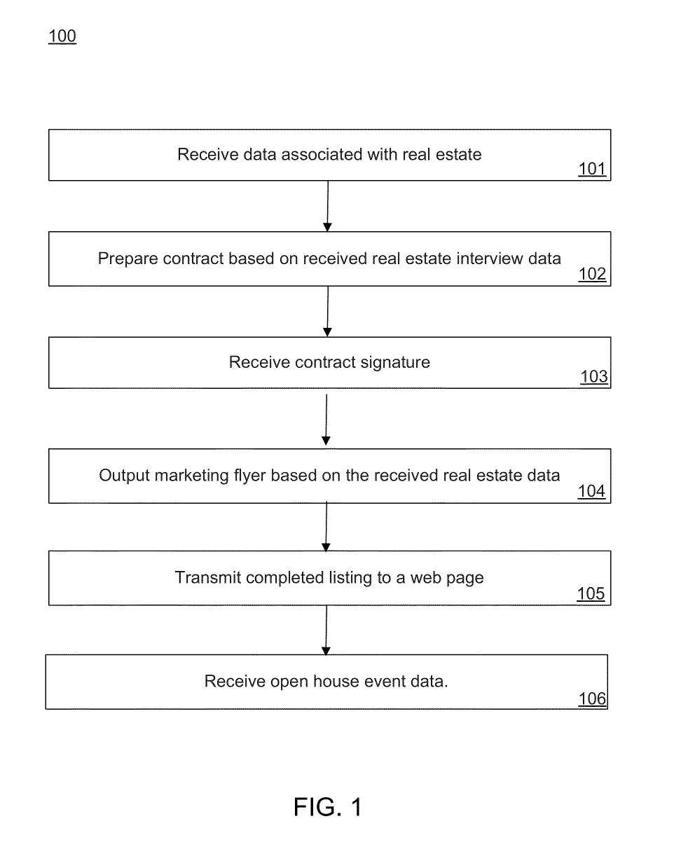

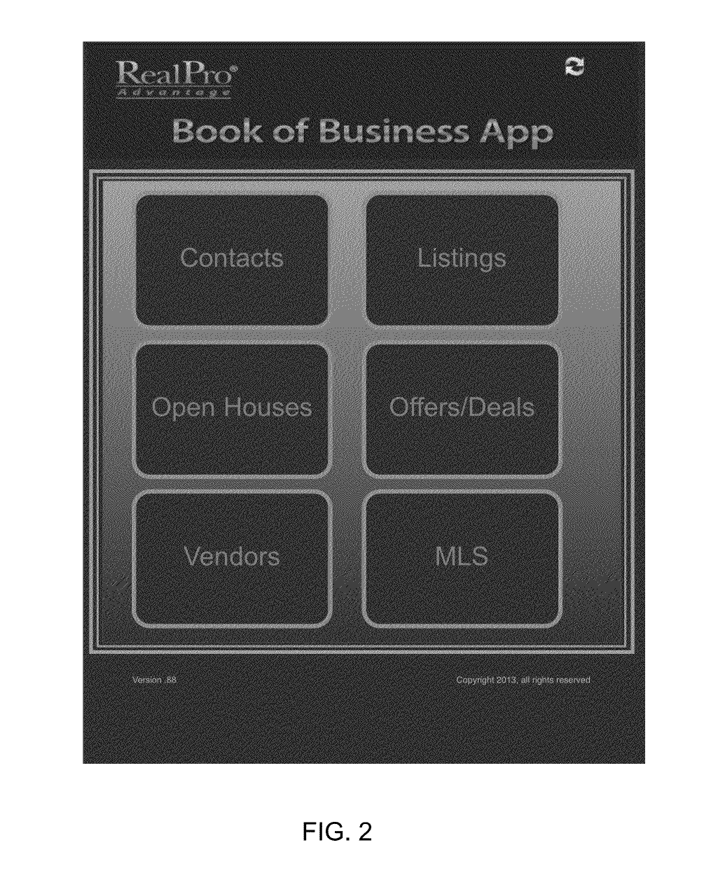

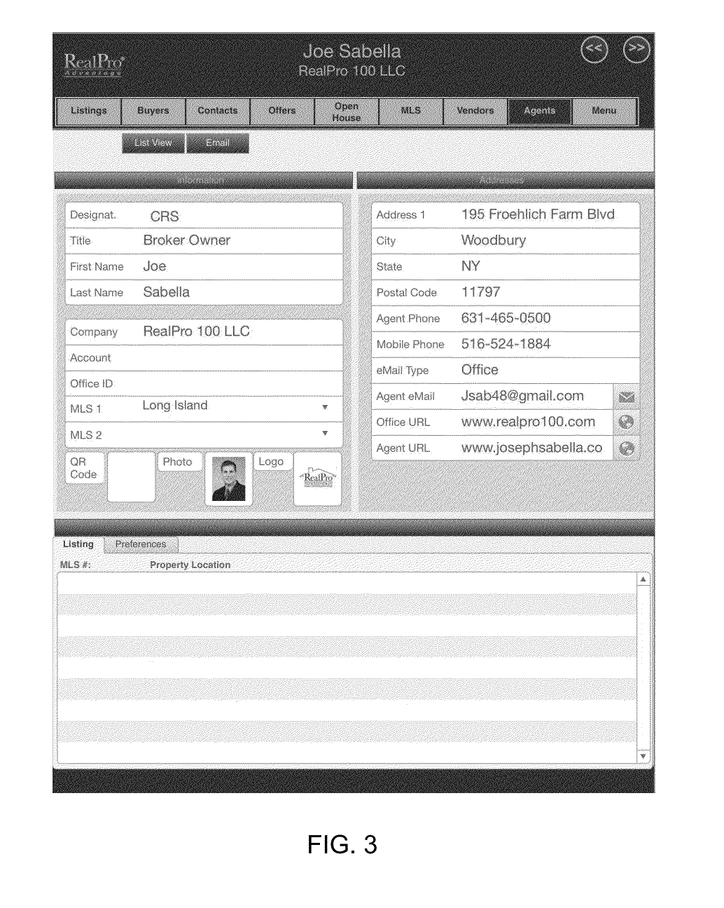

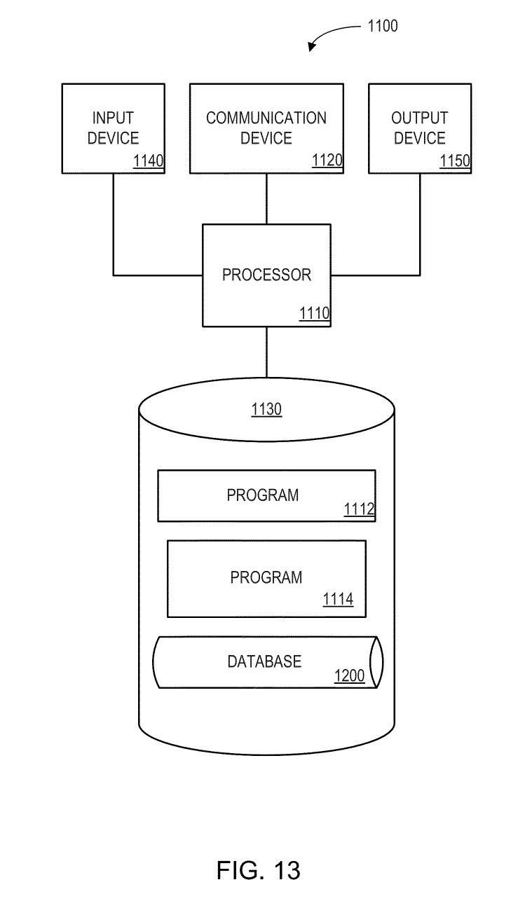

Referring now to FIG. 1, an embodiment of a method 100 is illustrated. The method 100 may be embodied on a non-transitory computer-readable medium. Furthermore, the method 100 may be performed by an apparatus such as, but not limited to, the apparatus of FIG. 13. The method 100 may relate to a real estate listing application that may create a more efficient method by which real estate agents create listing materials and agreements with customers by using a mobile device (e.g., a tablet or smartphone). The method may be associated with a software application being executed on the mobile device while the real estate agent is located on the premises of the real estate property that will be listed for sale. An example screen of the application that is associated with various functions of the application is illustrated in FIG. 2. Furthermore, the application may be associated with a particular agent/broker and information associated with the agent/broker may be entered in FIG. 3. Further note that the flow charts described herein do not imply a fixed order to the steps, and embodiments of the present invention may be practiced in any order that is practicable.

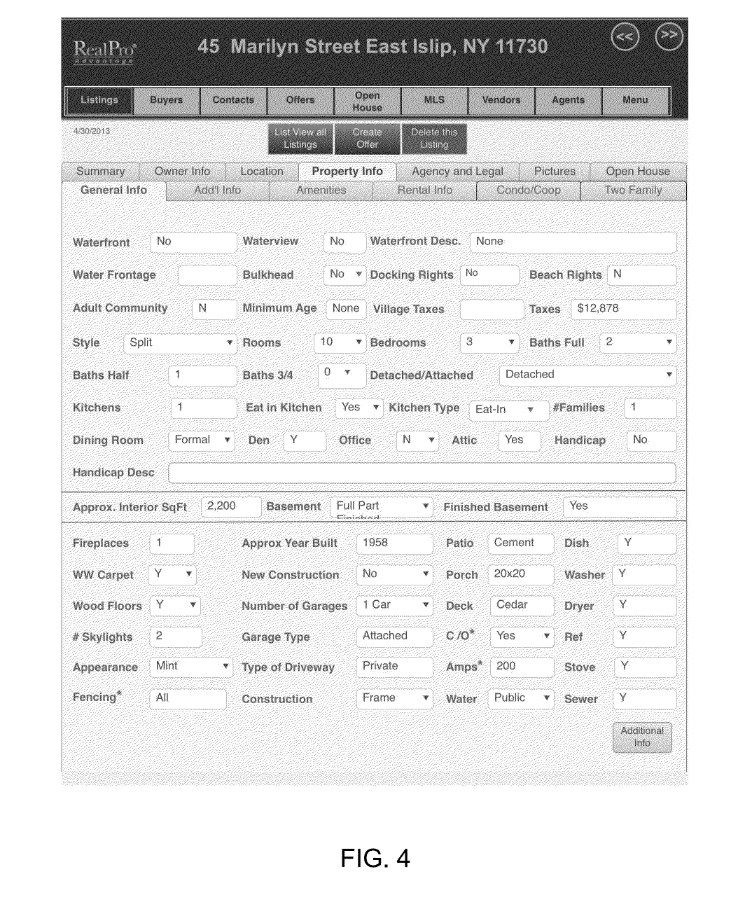

Referring back to FIG. 1, at 101, data associated with a particular real estate property is received. The particular real estate property may comprise, but it is not limited to, a house, a condominium, a building, or raw land. In some embodiments, a real estate agent may visit a prospective seller's home and record all pertinent information about the home by using a mobile device while at the home. In this regard, information associated with the property may only be entered once instead of writing the information by hand and then later entering the information into a computer. The data may be associated with a property inspection to determine room sizes, home features, mechanical aspects of the house, as well as exterior features of the property. The information recording may be based on a document form stored in the mobile device (e.g. memory of the mobile device). The document form may contain appropriate blank fields for information input. For example, FIG. 4 illustrates an example document for entering information associated with a property. In some embodiments, the form is associated with a database which is illustrated in FIG. 13. In some embodiments, the received data may comprise global positioning system (“GPS”) coordinates from an onboard GPS receiver. The GPS receiver may confirm or determine a location of the particular real estate property. For example, if the seller is unsure of an exact location of the property, the GPS receiver may receive coordinates of the property which may then be automatically looked up in a database to determine an exact address of the particular real estate property.

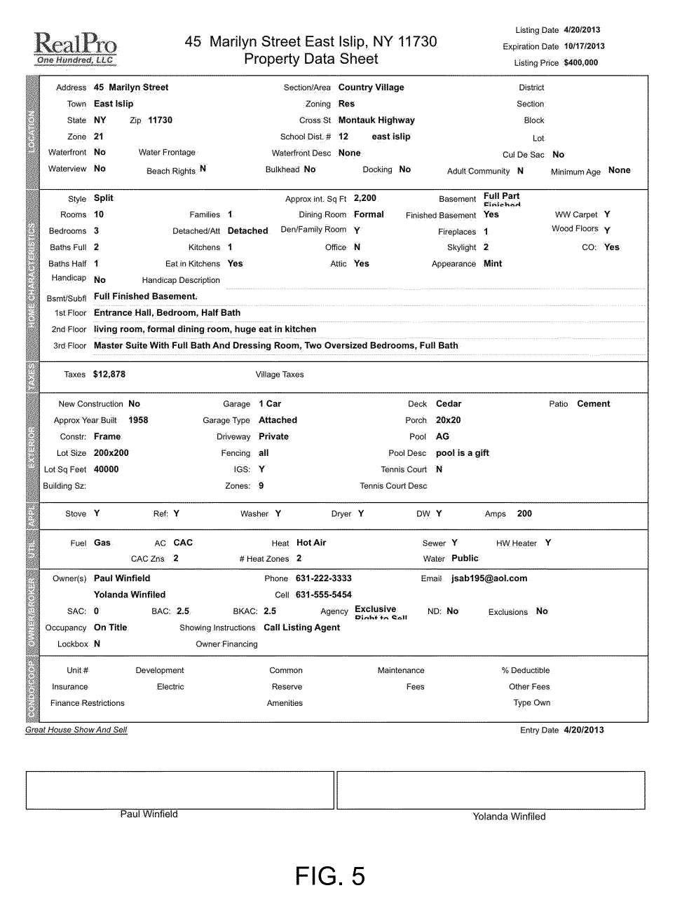

While the real estate agent interviews the prospective seller to complete the document form, the agent may utilize the mobile device to take photographic images of the property using a camera that is integrated in the mobile device. Photographic images may be received at the mobile device and the photographed images may be stored in the database or in container fields. In some embodiments, a limit to a number of images that can be stored may be determined. For example, agents may be limited to storing a maximum of twenty images. An example of a completed property data sheet is illustrated in FIG. 5.

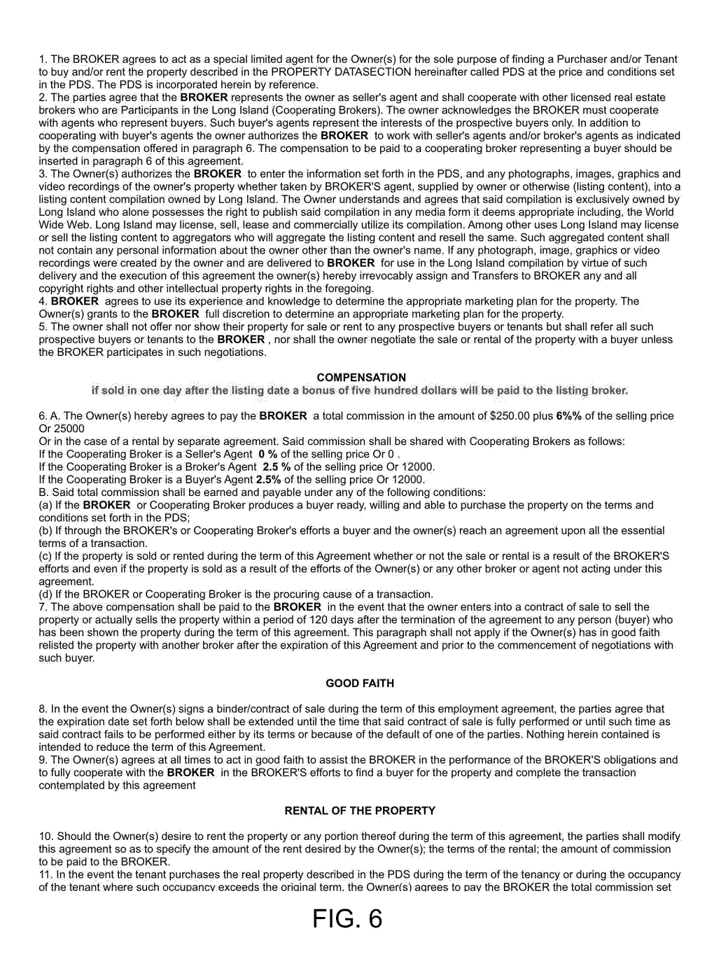

At 102, a contract based on the received data is created. The contract may be created via a processor. For example, after all of the listing information is gathered and images have been taken, a listing contract may be populated with all applicable blank fields completed. An example of a property contract is illustrated in FIG. 6.

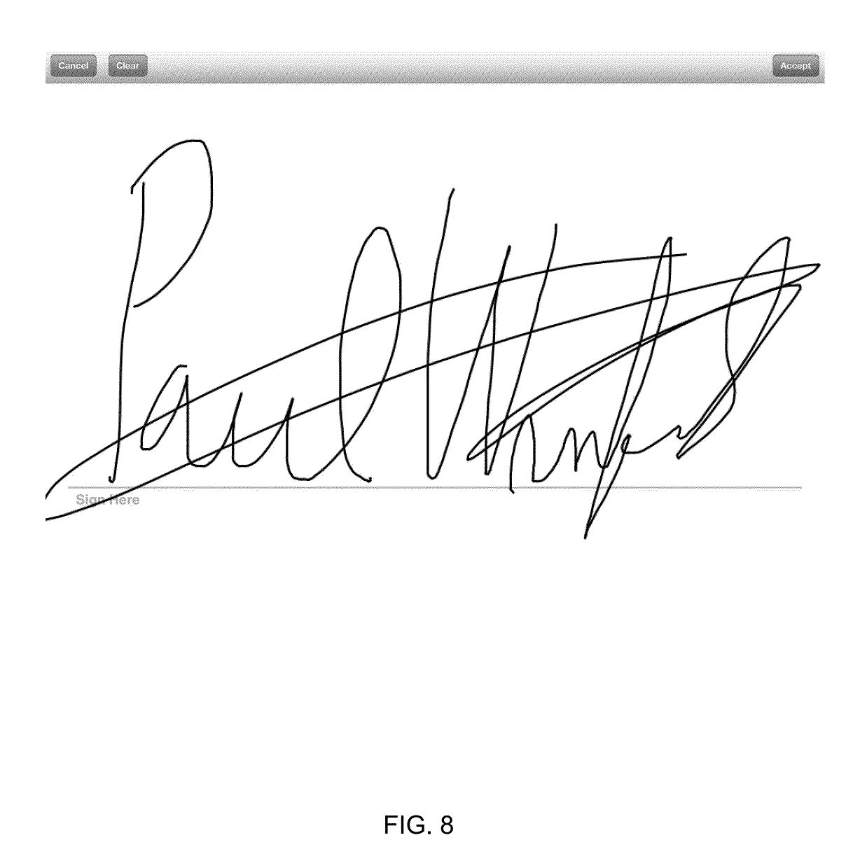

Next, at 103, a contract signature may be received. The contract may be signed immediately in the prospect's home by a finger action, or stylus, on a display screen (e.g., an electronic signature). The signature may be signed by the owner of the real estate property to be listed in a container field which may be used to store data that may be tracked in a database. FIG. 8 illustrates an example of a signature received via a mobile device.

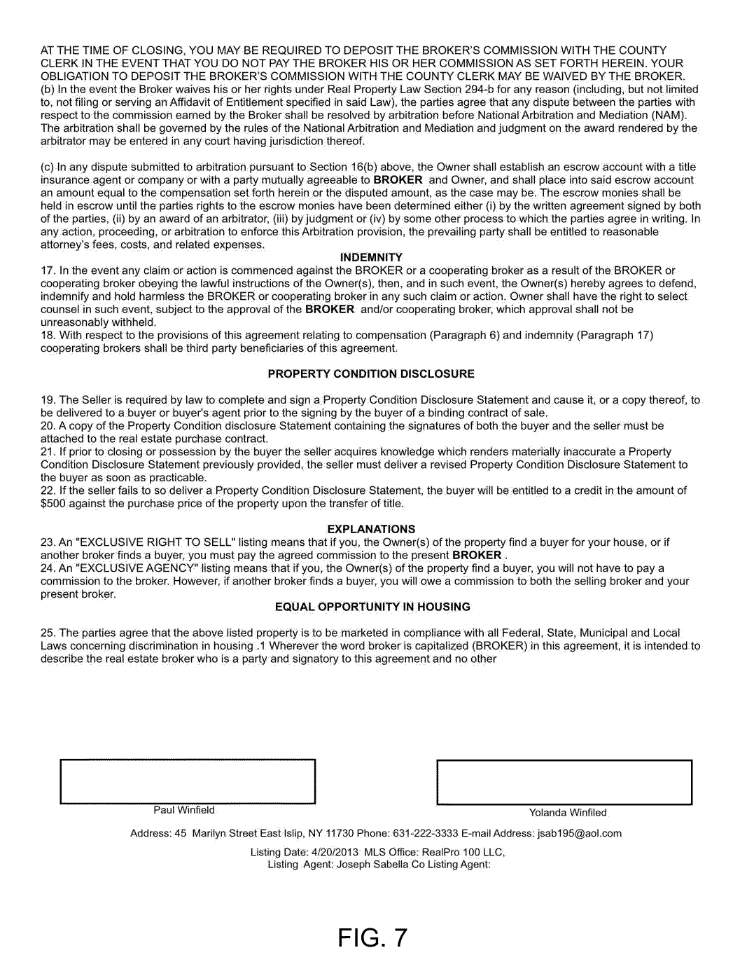

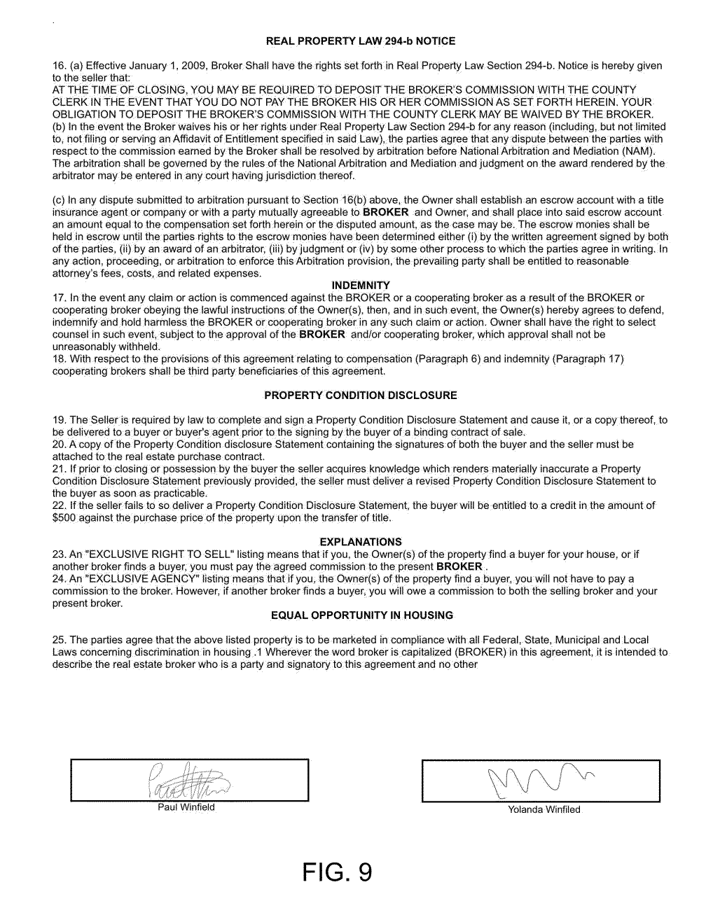

Once signed, the contract and disclosures may be saved as PDF files or emailed as disclosed in FIG. 7. PDF files, such as the PDF file illustrated in FIG. 9, may then be delivered to a perspective seller and all other parties via email, or can be printed immediately. Before the agent leaves the property being listed, the agent may produce and deliver to the seller a feature sheet (e.g., a flyer used for marketing the property).

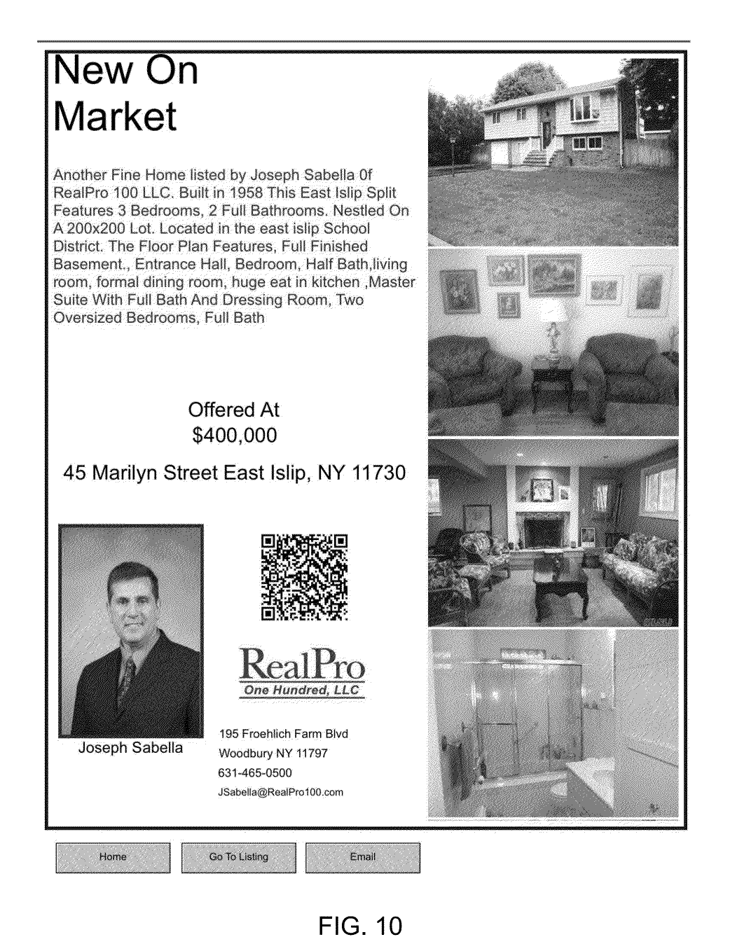

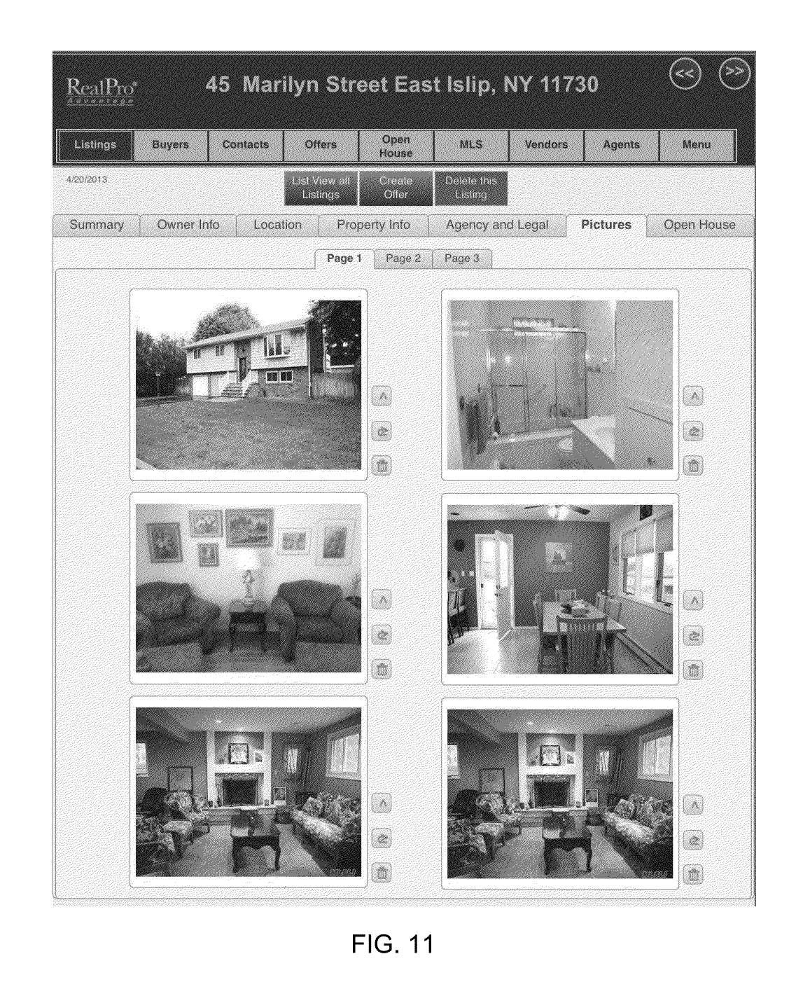

At 104, a marketing flyer based on the received real estate data is output. The marketing flyer (e.g., a feature sheet) is automatically prepared using the initial recorded information on the device or smartphone. For example, see FIG. 10 and FIG. 11 which illustrate a marketing flyer comprising a plurality of images associated with the property being listed.

If a seller of a piece of real estate is trying to sell “By Owner”, the real estate agent may provide a gift in the form of a Highlight Sheet that can be e-mailed in a PDF format. All the flyers may be printable or may be emailed in a PDF format instantly.

The complete listing may then be automatically transmitted (e.g., uploaded) to a broker's web page and/or an online listing service at 105 while the real estate agent is physically located at the real estate property to be listed. All information and photographs are transmitted (e.g., a cellular network) to the broker's Internet server. Property photos and listing information may appear within seconds or a couple of minutes on the broker's website, before the agent leaves the property. In some embodiments, the uploading process may be triggered automatically in response to the execution of the contract. According to some embodiments, listing a property on a website prior to the agent leaving the property may improve awareness of the listed property.

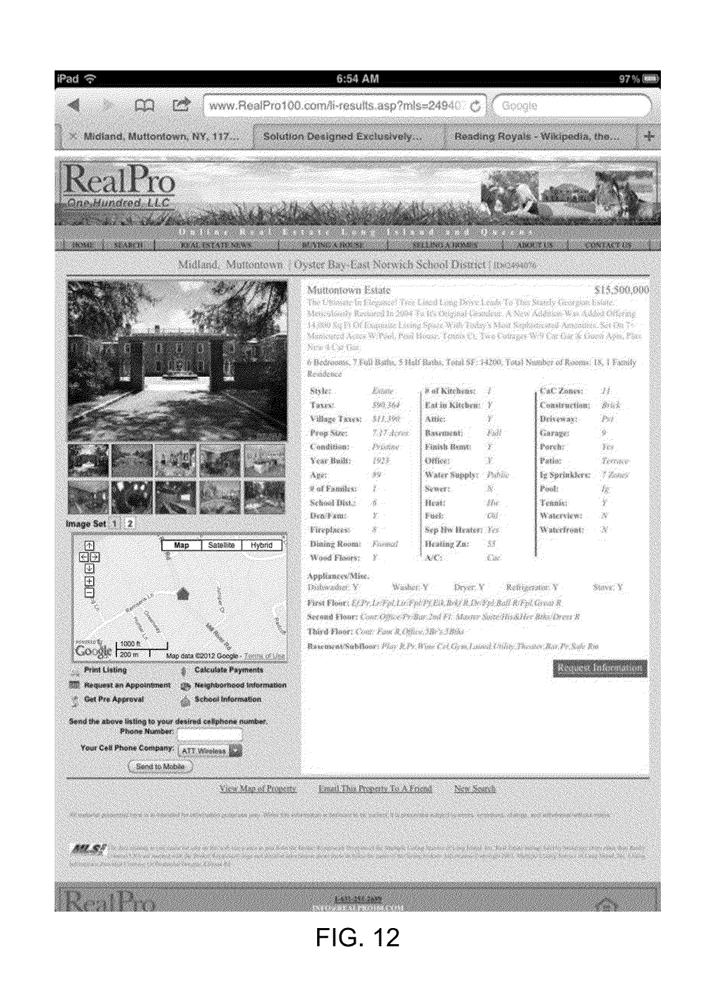

For example, FIG. 12 illustrates an example web page that illustrates the web page formatted data transmitted via the mobile device. Moreover, the listing contract is also fully signed (e.g., executed) and enforceable before the agent concludes the property visit. Therefore, the process of getting a property listed and its existence known to the public will be greatly reduced.

In some embodiments, listing data and pictures are automatically synchronized with a Structure Query Language (“SQL”) based server and may be syndicated to portals of a user's choice (e.g., an online service) or to the user's personal or company website. In some embodiments, the listing may be published to a web page before a real estate agent walks out the door of a property to be sold.

Now referring to FIG. 13, FIG. 13 is a block diagram overview of an apparatus 1100 according to some embodiments. The apparatus 1100 may comprise a mobile device, such as a phone or tablet. The apparatus 1100 comprises a processor 1110, such as one or more commercially available Central Processing Units (CPUs) in the form of one-chip microprocessors, coupled to a communication device 1120 configured to communicate via a communication network (not shown in FIG. 13). The communication device 1120 may comprise a wireless transceiver to send/receive data via a cellular or other wireless network or communication such as, but not limited to, a GPS transceiver and/or a wireless network interface card. The communication device 1120 may be used, for example, as an input path to receive information about real estate properties. The apparatus 1300 further includes an input device 1140 (e.g., a touchscreen for navigation of a web page or software application) and an output device 1150 (e.g., a touchscreen to display the web page or software application).

The processor 1110 communicates with a storage device 1130. The storage device 1130 may comprise any appropriate information storage device, including combinations of magnetic storage devices (e.g., a hard disk drive), optical storage devices, and/or semiconductor memory devices. The storage device 1130 stores one or more programs 1112/1114 for controlling the processor 1110. The processor 1110 performs instructions of the program 1112 and thereby operates in accordance with any of the embodiments described herein. In some embodiments, the storage device may comprise a computer-readable medium that may store processor-executable instructions to be executed by the processor 1110. For example, a computer-readable medium may comprise a non-transitory tangible medium such as, but is not limited to, a compact disk, a digital video disk, flash memory, optical storage, random access memory, read only memory, or magnetic media.

The program 1112 may be stored in a compressed, uncompiled and/or encrypted format. The program 1112 may furthermore include other program elements, such as an operating system, a database management system, and/or device drivers used by the processor 1110 to interface with peripheral devices.

As used herein, information may be “received” by or “transmitted” to, for example: (i) the apparatus 1100 from another device; or (ii) a software application or module within the apparatus 1100 from another software application, module, or any other source.

In some embodiments (such as shown in FIG. 13), the storage device 1130 stores a database 1200 (e.g., including information associated with the mobile device and/or information associated with real estate.). In some embodiments, the database 1200 may comprise, but is not limited to, a FILEMAKER database. In some embodiments, the database comprises a contact database. For example if an agent wants to meet a buyer at a local coffee shop the agent may enter the buyer's info into the contact database, activate a control (e.g., a button on a touch screen) and present the buyer with proper disclosures and buyer representation agreements. Moreover, various databases might be split or combined in accordance with any of the embodiments described herein. In some embodiments, the apparatus 1100 may comprise an onboard database and/or may connect to a remote database. In some embodiments, the database 1200 may be onboard and/or remote (e.g., a central database that multiple apparatuses may access).

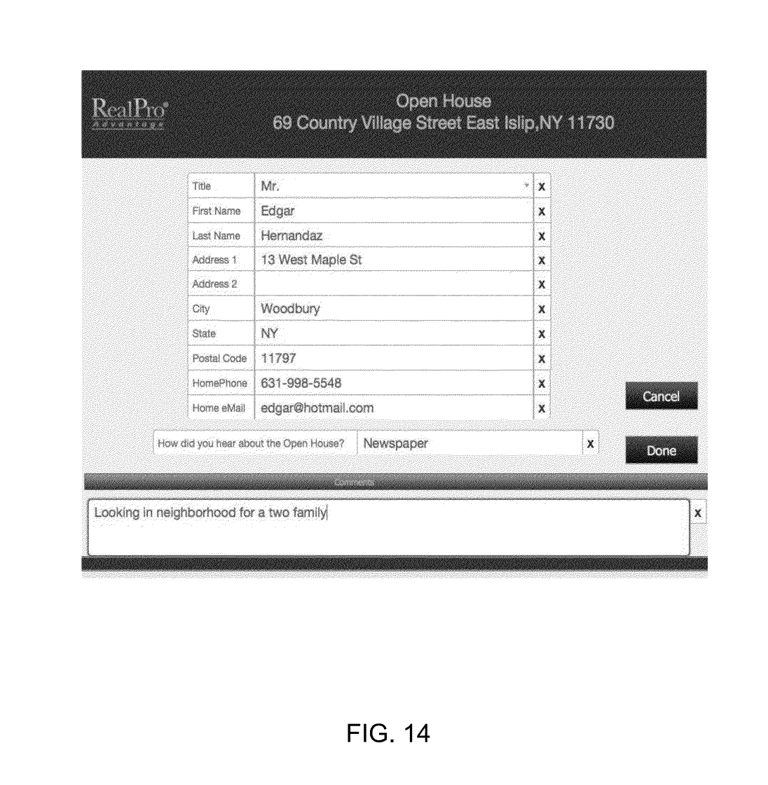

Referring back to FIG. 1, at 106 open house event data may be received. Now referring to FIG. 14, an embodiment of an open house sign-in screen is illustrated. In some embodiments, when guests enter an open house event they are asked to sign their name to a sign-in sheet. An open house event may comprise house, condominium or apartment that is open for inspection by prospective buyers. Using an apparatus such as that described above, contact information associated with visitors to the open house event may be collected and contact records in the database may be automatically created. Furthermore, all open house event data that is collected may be linked (e.g., connected to) the open house property. Since, the open house event data is linked to the property, this data may be used for negotiation purposes.

For example, when a buyer (or a buyer's agent) is asking a seller for a price adjustment or when the seller's agent is asking for an extension on the listing, a case may be made by presenting the seller/homeowner with a list of every open house event that the agent conducted along with the dates, times and names of every person that came through the open house event. Therefore, the dates, times and names of each person that attended the open house may be correlated by the real estate agent that conducted the open house event.

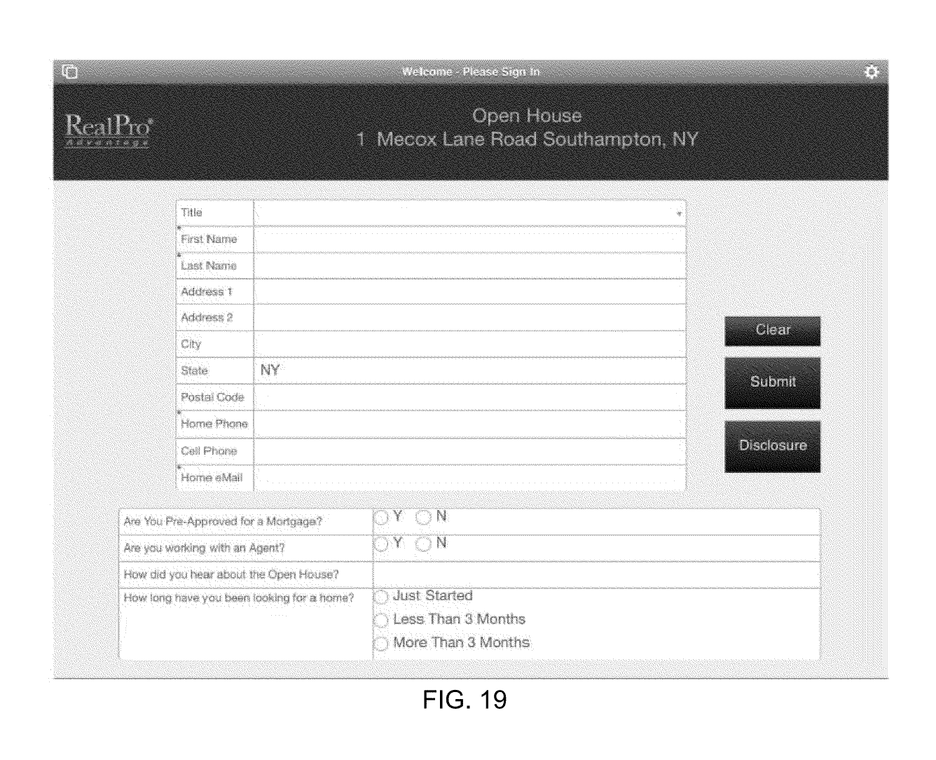

The open house sign-in-screen may also collect data associated with how a visitor to the open house learned of the open house such as illustrated in FIG. 19. Furthermore, the sign in screen may allow visitors to the open house to enter in data about a type of property they are looking for. In some embodiments, the apparatus may receive a real estate agent's credentials associated with the real estate agent's badge or identification card (e.g., by scanning the badge or identification card using an external scanner or via a built in camera in the mobile device). The apparatus may determine (e.g., authenticate) if the real estate agent is a licensed agent based on the received credentials and by wirelessly connecting to a database that lists licensed real estate agents. If the apparatus determines that a real estate agent is not a currently licensed real estate agent, the apparatus may alert the sellers of the property associated with the open house (or the seller's agent) that a real estate agent isn't currently licensed. The alert may be in a form of a text message, email, or an audible alarm.

Furthermore, in one embodiment, the apparatus may receive a visitor's (e.g., a potential buyer) credentials associated with a government issued identification card (e.g., a driver's license) by scanning the government issued identification via an external scanner or via a built in camera in the mobile device. The apparatus may parse the data scanned from the card and populate a database with all information disclosed on the identification card (e.g., name, address, driver's license number, etc.). The apparatus may only display a name of the visitor on the apparatus. However, if a crime is subsequently committed at the property associated with the open house event (e.g., something is stolen or a break-in occurs) the agent may be able to electronically transfer information associated with the visitors from the database to law enforcement officials to aid in an investigation of the crime. In some embodiments, when the same visitor enters a second open house event, the apparatus may determine that the visitor's information has already been stored. Therefore, the apparatus may determine to only associate the visitor with the second open house event and not store the visitor's information.

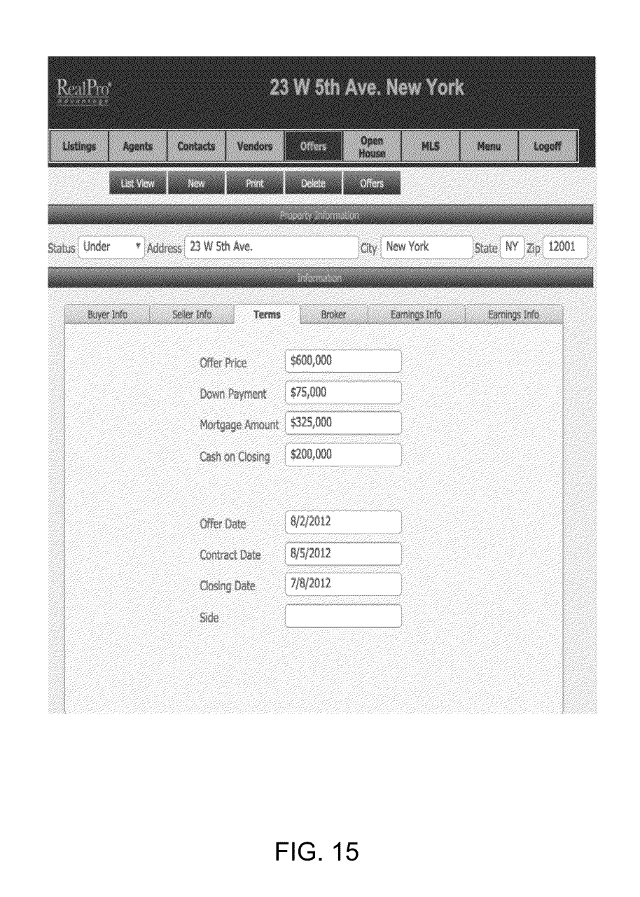

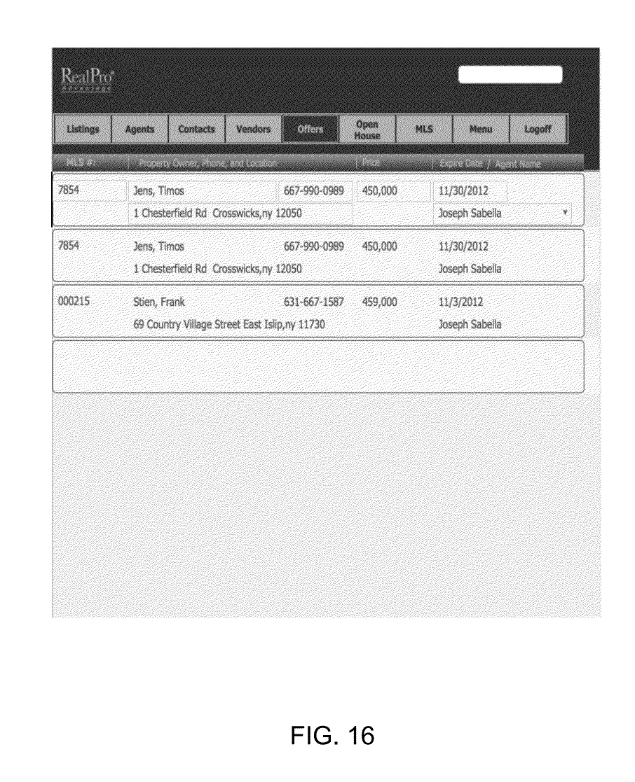

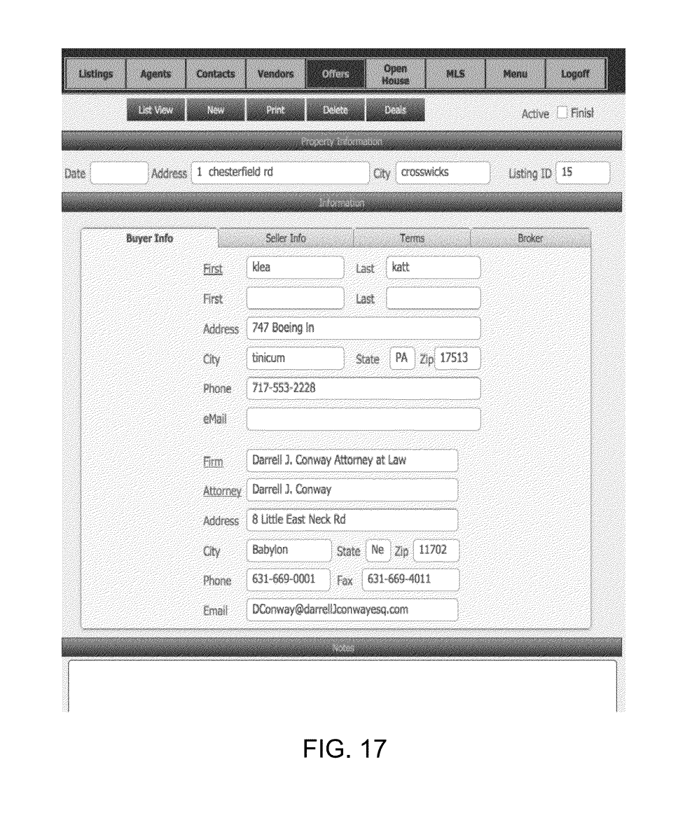

FIGS. 15 through 17 illustrate embodiments of offers screens. The apparatus, as described above, may store offers and deals and relate the information associated with the offer or deal to a specific property listing. By activating a button on an offer screen, an agent may see the status of all offers, including offers that are currently pending as well as offers that are closed (i.e., no longer pending). The offers screen may comprise information such as, but not limited to, an offer price, a down payment, a mortgage amount, and an amount of cash at closing. A buyer may also be able to receive an email or a text message that contains all previous offers to assist the buyer in determining an offer of his own.

Since email addresses, and cell phone numbers, may be stored in the contact database, offers may be emailed to a party of the transaction by activating a button to create a new email message or may be sent via a text message. Emails/texts may also be tracked and stored.

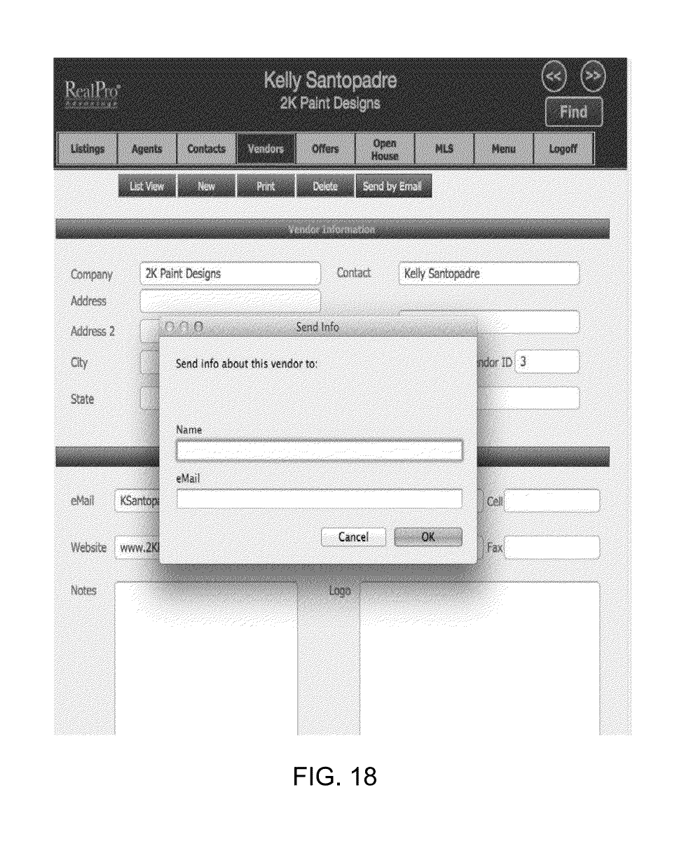

FIG. 18 may illustrate a vendor service screen according to some embodiments. The database may also store ancillary service providers associated with preparing a real estate property for sale such as, but not limited to, home inspectors, stagers, plumbers, carpenters, etc. For example, if a client asks his agent for a good home stager, the agent may press a button on a screen and a list of stagers local to the client's address may be displayed. Once displayed on the screen, selection of a vendor may email or text the vendor contact information to the client and optionally to the vendor to provide the vendor with information about the client as well as a source of the referral. An editing mechanism may allow pre-loaded server providers to be deleted and new service providers to be added. Venders may pay a fee to be listed in the database. For example, a vendor may pay a yearly fee to be listed in the database and the agent may enter the vendor's payment information using the apparatus (e.g., credit card or account information). Therefore, revenue may be generated by including a list of vendors in the database.

The apparatus may also be linked to one or more multi-listing service (“MLS”) databases. By being integrated with MLS databases, potential buyers may browse through available property inventory using the apparatus. If a buyer wants to see a property, the buyer may activate a “Show Me” button. Automatically, the listing may be text messaged (e.g., SMS text messaged) to a cell phone. By selecting the link in the text message, a user of a mobile device may be redirected via a mobile browser to a private web page that contains all of the listing information including showing instructions and contact information. By selecting a phone number in the listing the user's cell phone may dial the number and connect the user with the listing office so that an appointment may be scheduled.

The apparatus also comprises security. In a case where a real estate agency uses a plurality of apparatuses, each apparatus may be synchronized to a database server. When an agent leaves the employment of the real estate agency the agency may be able to lock out the agent's apparatus from accessing the database.

Various modifications and changes may be made to the foregoing embodiments without departing from the broader spirit and scope set forth in the appended claims. The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

What is claimed is:

1. A method to wirelessly facilitate the sale of real estate, the method comprising:
receiving data associated with a particular real estate property;
receiving an electronic signature of a seller of the particular real estate property;
creating, via a processor, an executed contract based on the received data and the received electronic signature;
in response to the executed contract, automatically transmitting the received data wirelessly, via the processor, to an online listing service.

2. The method of claim 1, further comprising:
linking an open house event to the particular real estate property; and
outputting, via the processor, dates, times and names of each person that attended the open house event correlated by a real estate agent that conducted the open house event.

3. The method of claim 2, further comprising:
receiving scanned identification associated with a real estate agent entering the open house event;
authenticating, via the processor, the entering real estate agent based on the receiving scanned identification; and
when a determination is made that the entering real estate agent is not a licensed agent, wirelessly transmitting an alert.

4. The method of claim 2, further comprising:
receiving scanned identification associated with a visitor entering the open house event;
storing, via the processor, information associated with the visitor's scanned identification;
receiving scanned identification associated with the visitor entering a second open house event;
determining that the visitor's information has already been stored;
determining to associate the visitor with the second open house event while not storing the visitor's information; and
when a crime is committed subsequent to the first open house event or the second open house event, electronically transferring the information associated with visitor's scanned identification to law enforcement.

5. The method of claim 1, further comprising:
receiving information about one or more offers associated with the particular real estate property wherein the information comprises: a status, an offer price, a down payment amount, a mortgage amount, and an amount of cash at closing; and
wirelessly transmitting, via the processor, the information associated with each of the one or more offers.

6. The method of claim 1, further comprising:
determining an address of the particular real estate property based on received GPS coordinates.

7. The method of claim 1, further comprising:
in response to the executed contract, automatically creating a marketing flyer, via the processor, and wirelessly transmitting the marketing flyer.

8. The method of claim 1, wherein the receiving, creating and automatically transmitting occur at the particular real estate property.

9. A non-transitory computer-readable medium comprising instructions to wirelessly facilitate the sale of real estate that when executed by a processor performs a method, the method comprising:
receiving data associated with a particular real estate property;
receiving an electronic signature of a seller of the particular real estate property;
creating, via a processor, an executed contract based on the received data and the received electronic signature;
in response to the executed contract, automatically transmitting the received data wirelessly, via the processor, to an online listing service.

10. The medium of claim 9, wherein the method further comprises:
linking an open house event to the particular real estate property; and
outputting, via the processor, dates, times and names of each person that attended the open house event correlated by a real estate agent that conducted the open house event.

11. The medium of claim 10, wherein the method further comprises:
receiving scanned identification associated with a real estate agent entering the open house event;
authenticating, via the processor, the entering real estate agent based on the receiving scanned identification; and
when a determination is made that the entering real estate agent is not a licensed agent, wirelessly transmitting an alert.

12. The medium of claim 9, wherein the method further comprises:
receiving information about one or more offers associated with the particular real estate property wherein the information comprises: a status, an offer price, a down payment amount, a mortgage amount, and an amount of cash at closing; and
wirelessly transmitting, via the processor, the information associated with each of the one or more offers.

13. The medium of claim 9, wherein creating an executed contract based on
determining an address of the particular real estate property based on received GPS coordinates.

14. The medium of claim 9, wherein the method further comprises:
in response to the executed contract, automatically creating a marketing flyer, via the processor, and transmitting the marketing flyer.

15. The medium of claim 9, wherein the receiving, creating and automatically transmitting occur at the particular real estate property.

16. An apparatus comprising:
a processor;
a non-transitory computer-readable medium comprising instructions to wirelessly facilitate the sale of real estate that when executed by the processor perform a method, the method comprising:
receiving data associated with a particular real estate property;
receiving an electronic signature of a seller of the particular real estate property;
creating, via a processor, an executed contract based on the received data and the received electronic signature;
in response to the executed contract, automatically transmitting the received data wirelessly, via the processor, to an online listing service.

17. The apparatus of claim 16, wherein the method further comprises:
linking an open house event to the particular real estate property; and
outputting, via the processor, dates, times and names of each person that attended the open house event correlated by a real estate agent that conducted the open house event.

18. The apparatus of claim 17, wherein the method further comprises:
receiving scanned identification associated with a real estate agent entering the open house event;
authenticating, via the processor, the entering real estate agent based on the receiving scanned identification;
when a determination is made that the entering real estate agent is not a licensed agent, wirelessly transmitting an alert;
receiving scanned identification associated with a visitor entering the open house event;
storing, via the processor, information associated with the visitor's scanned identification;
receiving scanned identification associated with the visitor entering a second open house event;
determining that the visitor's information has already been stored;
determining to associate the visitor with the second open house event while not storing the visitor's information; and
when a crime is committed subsequent to the first open house event or the second open house event, electronically transferring the information associated with visitor's scanned identification to law enforcement.

19. The apparatus of claim 16, wherein the method further comprises:
receiving payment from an ancillary service provider associated with preparing the particular real estate property for sale;
in response to receiving a request for a service provider, transmitting information associated with the ancillary service to the seller of the particular real estate property; and
transmitting information associated with the seller of the particular real estate property to the ancillary service provider.
